(19) United States
(12) Patent Application Publication
(10) Pub. No.: US 2020/0299431 A1
(43) Pub. Date: Sep. 24, 2020

(54) Metallocene Polyethylene for Pipe Applications

(71) Applicant: ExxonMobil Chemical Patents Inc., Baytown, TX (US)

(72) Inventors: Haiqing Peng, Sugar Land, TX (US); Donald A. Winesett, Houston, TX (US); Yuan Mei, Shanghai (CN); Roel Barzin, Machelen (BE)

(21) Appl. No.: 16/894,055

(22) Filed: Jun. 5, 2020

(51) Int. Cl. C08F 210/16

(52) U.S. Cl. CPC C08F 210/16

(57) ABSTRACT

In an embodiment, a pipe includes a polyethylene composition that includes ethylene and an alpha-olefin comonomer, wherein the polyethylene composition has a melt index of from 0.1 g/10 min to 1 g/10 min, a density of from 0.93 g/cm³ to 0.94 g/cm³, and a melt index ratio of from 40 to 70, and wherein the pipe has a 20° C. long term hydrostatic strength of from 5 MPa to 10.1 MPa. In another embodiment, a method of making a pipe includes extruding any polyethylene composition described herein. In another embodiment, an article includes a polyethylene composition described herein. In another embodiment, a polyethylene composition having a melt index of from 0.1 g/10 min to 1 g/10 min, a density of from 0.93 g/cm³ to 0.94 g/cm³, and a melt index ratio of from 40 to 70 is provided.

### FIELD

This disclosure generally relates to a metallocene polyethylene composition, and more particularly to metallocene polyethylene compositions for pipe applications.

### BACKGROUND

Polyethylene (PE) is widely used for piping systems in, e.g., municipal, industrial, marine, mining, landfill, and agricultural applications. Applications include carrying potable water, wastewater, hot and cold water slurries, chemicals, hazardous wastes, and sometimes it) compressed gases.

Conventional polyethylenes used for pipe applications such as irrigation pipes, sewage pipes, domestic pipes (including under floor heating, snow melt systems, hot and cold water delivery) may have to meet specific standards. For example, polyethylene materials sold for pressure pipes may have to meet the so-called PE 80 or PE 100 ratings. Pipes manufactured from polyethylenes classified as PE 80-type or PE 100-type compositions should withstand a minimum circumferential stress, or hoop stress, of 8 MPa (PE 80) or 10 MPa (PE 100) at 20° C. for 50 years.

When the polyethylene pipes are used to transfer pressurized gases or liquids, the mechanical strength of the polyethylene composition might be critical. For example, higher density polyethylene compositions are beneficial for mechanical strength but may impact negatively other properties such as stress cracking and crack propagation. Molecular weight, molecular weight distribution, and comonomer distribution can also play a role in achieving a balanced set of properties, such as minimum required strength (MRS, which provides long-term strength and creep resistance), stress crack resistance, and rapid crack propagation resistance for a variety of applications. For example, PE 100 compositions typically have a high molecular weight, a high density, and are bimodal, while PE 80 compositions typically have a medium molecular weight, medium density, and are either unimodal or bimodal.

Conventional polyethylenes have a relatively poor Long Term Hydrostatic Strength (LTHS) at high temperatures. This has been a disadvantage of traditional polyethylenes and has rendered these materials unsuitable for use in piping with exposure to higher temperatures, such as domestic pipe applications.

Other key properties of polyethylene compositions for pipe applications include processability such as extrudability and maximizing pipe mechanical (short-term and long-term) properties. Polyethylene pipes with a small diameter, e.g., up to 20 mm, are fabricated at relatively fast rate of production. A fast extrusion rate, however, can introduce finishing issues such as melt fracture and result in poor surface finish. Further, increased extrusion rates can impact properties such as the smooth surface finish required by the International Standard Organization (“ISO”) 22391.

Therefore, what is needed are polyethylene compositions, and their applications in an article (e.g., a pipe), which offers an advantageously balanced combination of mechanical, thermal, and processing properties, and which maintain their physical properties (e.g., MRS (minimum required strength), stress crack resistance, and rapid crack propagation resistance) in various environments.

### SUMMARY

This disclosure generally relates to a metallocene polyethylene composition, and more particularly to metallocene polyethylene compositions for pipe applications.

In an embodiment, a pipe is provided. The pipe includes a polyethylene composition containing ethylene and an alpha-olefin comonomer, wherein the polyethylene composition has a melt index (MI) of from 0.1 g/10 min to 1 g/10 min, measured according to method ASTM D1238, a density of from 0.93 g/cm³ to 0.94 g/cm³, measured according to method ASTM D1505, and a melt index ratio (MIR) of from 40 to 70, measured according to method ASTM D1238, and wherein the pipe has a 20° C. long term hydrostatic strength (LTHS) of from 5 MPa to 10.1 MPa, measured according to method ISO 1167 and method ISO 9080.

In another embodiment, a method of making a pipe includes extruding a polyethylene composition in a molten state through a die to form a pipe having a minimum required strength (MRS) of 8 MPa, wherein the MRS is per the definition of method ISO 1167 and method ISO 9080. The method further includes cooling the pipe.

In another embodiment, a method of making a pipe includes extruding a polyethylene composition in a molten state through a die to form a pipe having a hydrostatic design basis (HDB) of 1,250 psi at 73° F., wherein the HDB is per the definition of Plastic Pipe Institute (Irvine Tex.) Technical Report (TR) 3 and TR 4, ASTM D2837. The method further includes cooling the pipe.

In another embodiment, a method of making a pipe includes extruding a polyethylene composition in a molten state through a die to form a pipe, wherein the pipe has a σ_{LPL} greater or equal to 3.3 MPa, 2.7 MPa, 3.3 MPa, 2.4 MPa, or 6.7 MPa for class 1, 2, 4, 5, or cold water (20° C., 50 years) application, respectively, per method ISO 22391-2. The method further includes cooling the pipe.

In another embodiment, a method of making a pipe includes extruding a polyethylene composition in a molten state through a die to form a pipe, wherein the pipe has a σ_{LPL} greater or equal to 3.5 MPa, 3.4 MPa, 3.4 MPa, 2.9 MPa, or 7.5 MPa for class 1, 2, 4, 5, or cold water (20° C., 50 years) application, respectively, per method ISO 22391-2. The method further includes cooling the pipe.

In another embodiment, a method of making a pipe includes blending a polyethylene composition with a colorant to form a blend; extruding the blend in a molten state through a die to form a pipe. The method further includes cooling the pipe.

In another embodiment, a method of making a pipe includes blending a post-consumer polyethylene with a polyethylene composition. The method further includes extruding the pipe.

In another embodiment is provided an article that includes a polyethylene composition.

In another embodiment, a method of forming an article includes forming a polyethylene composition.

In another embodiment, a polyethylene composition includes ethylene and an alpha-olefin comonomer, wherein the polyethylene composition has a melt index (MI) of from 0.1 g/10 min to 1 g/10 min, measured according to method ASTM D1238, a density of from 0.93 g/cm³ to 0.94 g/cm³, measured according to method ASTM D1505, and a melt index ratio (MIR) of from 40 to 70, measured according to method ASTM D1238.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, for the disclosure may admit to other equally effective embodiments.

FIG. 1 shows the long-term hydrostatic strength of an example polyethylene composition according to some embodiments.

FIG. 2 shows the extensional viscosity of an example polyethylene composition according to some embodiments.

FIG. 3 shows the molecular weight properties of an example polyethylene composition according to some embodiments.

### DETAILED DESCRIPTION

The present disclosure includes medium density metallocene polyethylene compositions that are suitable for a variety of applications, e.g., pipe applications. The inventors have discovered medium density metallocene polyethylene compositions that have a minimum required strength (MRS) of 8 MPa. That is, the polyethylene compositions can have a σ_{LPL} from about 8 MPa to about 9.99 MPa and can have improved processability. Without being bound by any theory, such a unique property is believed to be a result of molecular characteristics including long chain branching of the polyethylene composition, as compared to conventional polymers used in pipe manufacturing. The long chain branching may be provided by the use of a metallocene catalyst to form the polyethylene compositions rather than, for example, a Ziegler Natta based catalyst.

In addition, the polyethylene compositions can have a higher melt index ratio (such as greater than 40, such as greater than 50) compared with traditional Ziegler-Natta resins and other metallocene resins, a broader molecular weight distribution compared with traditional Ziegler-Natta resins and metallocene resins, a larger molecular weight ratio compared with traditional Ziegler-Natta resins and metallocene resins, a good comonomer distribution, and are unimodal. Such a combination of chemical properties is not achievable when using Ziegler-Natta and other metallocene catalysts.

The polyethylene compositions can also provide a better pressure rating than conventional polyethylene compositions and can be used to form pipes that are more flexible than conventional pipes. For example, the polyethylene pipes described herein can be more flexible than PE 80 pipes, allowing for fewer pipe connections needed during installation and use. Moreover, the polyethylene compositions can have better processability than conventional polyethylene compositions, such that the polyethylene compositions can be processed at high speeds without the use of polymer processing additives.

For purposes of the present disclosure, a “metallocene catalyst” refers to a catalyst having at least one transition metal compound containing one or more substituted or unsubstituted cyclopentadienyl moiety (“Cp”) (typically two Cp moieties) in combination with a Group 4, 5, or 6 transition metal (M). A metallocene catalyst is considered a single site catalyst. Metallocene catalysts typically require activation with a suitable co-catalyst, or activator, in order to yield an “active metallocene catalyst”, e.g., an organometallic complex with a vacant coordination site that can coordinate, insert, and polymerize olefins. Active catalyst systems generally include not only the metallocene complex, but also an activator, such as an alumoxane or a derivative thereof (for example, methyl alumoxane), an ionizing activator, a Lewis acid, or a combination thereof. Alkylalumoxanes (for example, methyl alumoxane and modified methylalumoxanes) are suitable as catalyst activators. The catalyst system can be supported on a carrier, typically an inorganic oxide or chloride or a resinous material such as, for example, polyethylene or silica.

For purposes of the present disclosure, medium density polyethylene (“MDPE”) refers to a polyethylene copolymer having a density from about 0.930 g/cm³ to about 0.950 g/cm³.

For purposes of the present disclosure, polymers having more than two types of monomers are referred to as copolymers. Polymers having three or more monomers, such as terpolymers, are also included within the term “copolymer.”

For purposes of the present disclosure, molecular weight distribution (“MWD”) is equivalent to the expression Mw/Mn. The expression Mw/Mn is the ratio of the weight average molecular weight (“Mw”) to the number average molecular weight (“Mn”). The weight average molecular weight is given by

$${M}_{w} = \frac{{\sum }_{i} {n}_{i} {M}_{i}^{2}}{{\sum }_{i} {n}_{i} {M}_{i}}$$

the number average molecular weight is given by

$${M}_{n} = \frac{{\sum }_{i} {n}_{i} {M}_{i}}{{\sum }_{i} {n}_{i}}$$

and the z-average molecular weight is given by

$${M}_{z} = \frac{{\sum }_{i} {n}_{i} {M}_{i}^{3}}{{\sum }_{i} {n}_{i} {M}_{i}^{2}}$$

where nᵢ in the foregoing equations is the number fraction of molecules of molecular weight Mᵢ. Measurements of Mw, Mz, and Mn are typically determined by Gel Permeation Chromatography as disclosed in Sun, T. et al. (2001) “Effect of Short Chain Branching on the Coil Dimensions of Polyolefins in Dilute Solutions,” Macromolecules, v34(19), pp. 6812-6820. The measurements proceed as follows. Gel Permeation Chromatography (Agilent PL-220), equipped with three in-line detectors, a differential refractive index detector (DRI), a light scattering (LS) detector, and a viscometer, is used. Experimental details, including detector calibration, are described in Sun, T. et al. (2001) “Effect of Short Chain Branching on the Coil Dimensions of Polyolefins in Dilute Solutions,” Macromolecules, v34(19), pp. 6812-6820. Three Agilent PLgel 10 μm Mixed-B LS columns are used. The nominal flow rate is 0.5 ml/min, and the nominal injection volume is 300 μL. The various transfer lines, columns, viscometer and differential refractometer (the DRI detector) are contained in an oven maintained at 145° C. Solvent for the experiment is prepared by dissolving 6 grams of butylated hydroxytoluene as an antioxidant in 4 liters of Aldrich reagent grade 1,2,4-trichlorobenzene (TCB). The TCB mixture is then filtered through a 0.1 μm Teflon filter. The TCB is then degassed with an online degasser before entering the GPC-3D. Polymer solutions are prepared by placing dry polymer in a glass container, adding the desired amount of TCB, then heating the mixture at 160° C. with continuous shaking for about 2 hours. All quantities are measured gravimetrically. The TCB densities used to express the polymer concentration in mass/volume units are 1.463 g/ml at about 21° C. and 1.284 g/ml at 145° C. The injection concentration is from 0.5 to 2.0 mg/ml, with lower concentrations being used for higher molecular weight samples. Prior to running each sample, the DRI detector and the viscometer are purged. The flow rate in the apparatus is then increased to 0.5 ml/minute, and the DRI is allowed to stabilize for 8 hours before injecting the first sample. The LS laser is turned on at least 1 to 1.5 hours before running the samples. The concentration, c, at each point in the chromatogram is calculated from the baseline-subtracted DRI signal, I_{DRI}, using the following equation:

c=(K_{DRI}I_{DRI})/(dn/dc)

where K_{DRI} is a constant determined by calibrating the DRI, and (dn/dc) is the refractive index increment for the system. The refractive index, n=1.500 for TCB at 145° C. and λ=690 nm. Units for parameters throughout this description of the GPC-3D method are such that concentration is expressed in g/cm³, molecular weight is expressed in g/mole, and intrinsic viscosity is expressed in dL/g.

The LS detector is a Wyatt Technology High Temperature DAWN HELEOS. The molecular weight, M, at each point in the chromatogram is determined by analyzing the LS output using the Zimm model for static light scattering (M. B. Huglin (1971) Light Scattering from Polymer Solutions, Academic Press):

$$\frac{{K}_{o} c}{Δ R ( θ )} = \frac{1}{MP ( θ )} + 2 {A}_{2} c$$

where ΔR(θ) is the measured excess Rayleigh scattering intensity at scattering angle θ, c is the polymer concentration determined from the DRI analysis, A₂ is the second virial coefficient, P(θ) is the form factor for a monodisperse random coil, and Kₒ is the optical constant for the system:

$${K}_{o} = \frac{4 {π}^{2} {{n}^{2} ( dn / d c )}^{2}}{{λ}^{4} {N}_{A}}$$

where N_{A} is Avogadro's number, and (dn/dc) is the refractive index increment for the system, which takes the same value as the one obtained from DRI method. The refractive index, n=1.500 for TCB at 145° C. and λ=657 nm.

A high temperature Viscotek Corporation viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, η_{S}, for the solution flowing through the viscometer is calculated from their outputs. The intrinsic viscosity, [η], at each point in the chromatogram is calculated from the following equation:

η_{S}=[η]+0.3(c[η])²

where c is concentration and was determined from the DRI output.

The branching index (g′ᵥᵢₛ) is calculated using the output of the GPC-DRI-LS-VIS method as follows. The average intrinsic viscosity, [η]_{avg} of the sample is calculated by:

$${[ η ]}_{avg} = \frac{\sum {{c}_{i} [ η ]}_{i}}{\sum {c}_{i}}$$

where the summations are over the chromatographic slices, i, between the integration limits.

The branching index g′ᵥᵢₛ is defined as:

$${g}^{′} vis = \frac{{[ η ]}_{a v g}}{k {M}_{v}^{α}}$$

where M_{V} is the viscosity-average molecular weight based on molecular weights determined by LS analysis. Z average branching index (g′_{Zave}) is calculated using Ci=polymer concentration in the slice i in the polymer peak times the mass of the slice squared, Mi². All molecular weights are weight average unless otherwise noted. All molecular weights are reported in g/mol unless otherwise noted. This method is the preferred method of measurement and used in the examples and throughout the present disclosure unless otherwise specified. See also, for background, Sun, T. et al. (2001) “Effect of Short Chain Branching on the Coil Dimensions of Polyolefins in Dilute Solutions,” Macromolecules, v34(19), pp. 6812-6820.

In an extrusion process, viscosity is a measure of resistance to shearing flow. Shearing is the motion of a fluid, layer-by-layer, like a deck of cards. When polymers flow through straight tubes or channels, they are sheared and the resistance is expressed by the viscosity. The melt index (“MI”) is the number of grams extruded in 10 minutes under the action of a standard load and is an inverse measure of viscosity. A high melt index implies low viscosity and low melt index means high viscosity. In addition, polymers are shear thinning, which means that their resistance to flow decreases as the shear rate increases. This is due to molecular alignments in the direction of flow and disentanglements.

Extensional or elongational viscosity is the resistance to stretching. In fiber spinning, in film blowing and other processes where molten polymers are stretched, the elongational viscosity plays a role. For example, for certain liquids, the resistance to stretching can be three times larger than in shearing. For some polymeric liquids, the elongational viscosity can increase (tension stiffening) with the rate, although the shear viscosity decreases.

Melt strength is a measure of the extensional viscosity and is defined as the maximum tension that can be applied to the melt without breaking. Extensional viscosity is the polymer's ability to resist thinning at high draw rates and high draw ratios. In melt processing of polyolefins, the melt strength is defined by two key characteristics that can be quantified in process related terms and in rheological terms. In extrusion blow molding and melt phase thermoforming, a branched polyolefin of the appropriate molecular weight can support the weight of the fully melted sheet or extruded parison prior to the forming stage. This behavior is sometimes referred to as sag resistance.

When LLDPE polymers are extended in the melt phase, because of the lack of long chain branching, the chains align and tend to slide over one another. There is a momentary point where they begin to exhibit an increase in viscosity that is immediately flowed by the onset of shear thinning. The melt will thin out from specific points where the critical draw rate or draw ratio has been exceed. So, while a lower elongational viscosity permits the LLDPE to be easily down gauged since there is no strong tension stiffening, the low elongational viscosity and melt strength is often less ideal for formation of larger diameter PE-RT pipes.

Therefore, as provided herein, the present polyethylene compositions (also called polyethylene resins) can improve melt strength and shear thinning which can lower extrusion pressure and melt temperature to allow for faster extrusion rates. Through use of the polyethylene compositions described herein, the pipes can be produced at relatively fast extrusion rates without many of the finishing issues typically associated with the conventional processing of pipe (e.g., PE-RT pipes).

In some embodiments, the polyethylene compositions can include from about 50 mol % to about 100 mol % of units derived from ethylene. In some embodiments, the lower amount of ethylene content can be from about 50 mol %, about 75 mol %, about 80 mol %, about 85 mol %, about 90 mol %, about 92 mol %, about 94 mol %, about 95 mol %, about 96 mol %, about 97 mol %, about 98 mol %, about 99 mol %, or about 99.5 mol % based on the mol % of polymer units derived from ethylene. The polyethylene composition can have an upper amount of ethylene content of about 80 mol %, about 85 mol %, about 90 mol %, about 92 mol %, about 94 mol %, about 95 mol %, about 96 mol %, about 97 mol %, about 98 mol %, about 99 mol %, about 99.5 mol %, or about 100 mol %, based on polymer units derived from ethylene.

In some embodiments, the polyethylene copolymer can have a g′ᵥᵢₛ of less than about 0.99 or lower, such as less than about 0.95, such as from about 0.86 to about 0.95.

In some embodiments, the polyethylene compositions can be ethylene-based copolymers having from about 99.5 wt % to about 80 wt %, such as about 99 wt % to about 85 wt %, about 99 wt % to about 87.5 wt %, 99 wt % to 90 wt %, 99 wt % to 92.5 wt %, 99 wt % to 95 wt %, or 99 wt % to 97 wt %, of polymer units derived from ethylene and about 0.5 wt % to about 20 wt %, such as about 1 wt % to about 20 wt %, about 1 wt % to about 15 wt %, about 1 wt % to about 12.5 wt %, about 1 wt % to about 10 wt %, about 1 wt % to about 7.5 wt %, about 1 wt % to about 5 wt %, or about 1 wt % to about 3 wt % of polymer units derived from one or more C₃ to C₂₀ alpha-olefin comonomers, such as C₃ to C₁₀ alpha-olefins, and for example C₄ to C₈ alpha-olefins. The alpha-olefin comonomer can be linear, branched, cyclic and/or substituted, and two or more comonomers can be used, if desired. Examples of suitable comonomers can include propylene, butene, 1-pentene; 1-pentene with one or more methyl, ethyl, or propyl substituents; 1-hexene; 1-hexene with one or more methyl, ethyl, or propyl substituents; 1-heptene; 1-heptene with one or more methyl, ethyl, or propyl substituents; 1-octene; 1-octene with one or more methyl, ethyl, or propyl substituents; 1-nonene; 1-nonene with one or more methyl, ethyl, or propyl substituents; ethyl, methyl, or dimethyl-substituted 1-decene; 1-dodecene; and styrene; and mixtures thereof.

In some embodiments, the polyethylene compositions can have a Mw of from about 80,000 g/mol to about 120,000 g/mol, such as from about 90,000 g/mol to about 110,000 g/mol.

In some embodiments, the polyethylene compositions can have a Mn of from about 20,000 g/mol to about 40,000 g/mol, such as from about 25,000 g/mol to about 35,000 g/mol.

In some embodiments, the polyethylene compositions can have an Mz of from about 160,000 g/mol to about 300,000 g/mol, such as from about 220,000 g/mol to about 280,000 g/mol.

In some embodiments, the polyethylene compositions can have a molecular weight distribution (MWD, defined as M_{w}/Mₙ) of from about 3 to about 6, such as from about 3.5 to about 4.5.

In some embodiments, the polyethylene compositions can be unimodal polyethylenes.

In some embodiments, the polyethylene compositions can have a melt index (MI 2.16), I_{2.16} or simply I₂ for shorthand, according to ASTM D1238, condition E (190° C./2.16 kg) reported in grams per 10 minutes (g/10 min), of greater than about 0.10 g/10 min, e.g., greater than about 0.15 g/10 min, greater than about 0.18 g/10 min, greater than about 0.20 g/10 min, greater than about 0.22 g/10 min, greater than about 0.25 g/10 min, greater than about 0.28, or greater than about 0.30 g/10 min. Additionally or alternately, the polyethylene compositions can have a melt index (I_{2.16}) of less than about 3 g/10 min, less than about 2 g/10 min, less than about 1.5 g/10 min, less than about 1 g/10 min, less than about 0.75 g/10 min, less than about 0.5 g/10 min, less than about 0.4 g/10 min, less than about 0.3 g/10 min, less than about 0.25 g/10 min, less than about 0.22 g/10 min, less than about 0.2 g/10 min, less than about 0.18 g/10 min, or less than about 0.15 g/10 min. Example ranges include ranges formed by combinations of any of the above-enumerated values, e.g., from about 0.1 g/10 min to about 5 g/10 min, from about 0.1 g/10 min to about 2 g/10 min, from about 0.1 g/10 min to about 1 g/10 min, and from about 0.2 g/10 min to about 0.8 g/10 min, such as from about 0.2 g/10 min to about 0.5 g/10 min or from about 0.4 g/10 min to about 0.6 g/10 min.

In some embodiments, the polyethylene compositions can have a High Load Melt Index (HLMI), I_{21.6} or I₂₁ for shorthand, measured in accordance with ASTM D1238, condition F (190° C./21.6 kg). For a given polymer having an MI and MIR as defined herein, the HLMI is fixed and can be calculated in accordance with the following paragraph.

The polyethylene compositions can have a Melt Index Ratio (MIR) which is a dimensionless number and is the ratio of the high load melt index to the melt index, or I_{21.6}/I_{2.16} as described above. In some embodiments, the MIR of the polyethylene compositions can be greater than 40, such as greater than 50. In some embodiments, the MIR of the polyethylene compositions can be from about 25 to about 80, such as from about 25 to about 70, such as from about 30 to about 55, and such as from about 35 to about 50. In some embodiments, the MIR of the polyethylene compositions can be from about 40 to about 60, such as from about 50 to about 60.

In some embodiments, the polyethylene composition can have a density of greater than about 0.93 g/cm³, such as greater than about 0.935 g/cm³, such as greater than about 0.94 g/cm³, such as greater than about 0.945 g/cm³, such as about 0.95 g/cm³. Alternately, and in some embodiments, the polyethylene compositions can have a density of less than about 0.95 g/cm³, such as less than about 0.945 g/cm³, e.g., less than about 0.94 g/cm³, such as less than about 0.937 g/cm³, such as less than about 0.935 g/cm³, and such as less than about 0.93 g/cm³. Example ranges include ranges formed by combinations of any of the above-enumerated values, e.g., from about 0.93 g/cm³ to about 0.95 g/cm³, from about 0.93 g/cm³ to about 0.945 g/cm³, from about 0.93 g/cm³ to about 0.94 g/cm³, from about 0.93 g/cm³ to about 0.935 g/cm³, from about 0.935 g/cm³ to about 0.94 g/cm³, from about 0.935 g/cm³ to about 0.950 g/cm³. Ranges also include from about 0.932 g/cm³ to about 0.938 g/cm³ and from about 0.934 g/cm³ at to about 0.937 g/cm³. Density is determined using chips cut from plaques compression molded in accordance with ASTM D-1928 Procedure C, aged in accordance with ASTM D-618 Procedure A, and measured as specified by ASTM D-1505.

The branching index, g′ᵥᵢₛ, is inversely proportional to the amount of branching of a polymer. Thus, lower values for g′ indicate relatively higher amounts of branching. The amounts of short and long-chain branching each contribute to the branching index according to the formula:

g′ᵥᵢₛ=g′_{LCB}×g′_{SCB}.

In some embodiments, the polyethylene compositions can have a g′ᵥᵢₛ of about 0.999 or below, such as from about 0.85 to about 0.99, such as from about 0.87 to about 0.97, such as from about 0.89 to about 0.95, such as from about 0.89 to about 0.94, such as from about 0.90 to about 0.94, such as from about 0.90 to about 0.93.

In some embodiments, the polyethylene compositions can have a F50 of greater than 1,000 hours, such as greater than 2,000 hours, such as greater than 5,000 hours, such as greater than 10,000 hours, when measured according to environmental stress crack resistance (ESCR) condition B with 10% Igepal per ASTM D1693.

In some embodiments, the flexural modulus (1% secant) of the polyethylene compositions can be from about 500 MPa to about 1,000 MPa, such as from about 600 MPa to about 900 MPa, for example from about 700 MPa to about 800 MPa. Flexural modulus (1% secant) is determined based on ASTM D882 and the specimens are molded per ASTM D4703.

In some embodiments, the tensile strength at yield of the polyethylene compositions can be from about 15 MPa to about 21 MPa, such as from about 16 MPa to about 20 MPa, for example from about 17 MPa to about 19 MPa. Tensile strength at yield is determined based on ASTM D882 and the specimens are molded per ASTM D4703.

In some embodiments, the elongation at yield of the polyethylene compositions can be from about 10% to about 11%, for example from about 9% to about 12%. Elongation at yield is determined based on ASTM D882.

In some embodiments, the polyethylene compositions can exhibit an inflection point in the Van-Gurp Palmen plot of the polyethylene composition, indicating the presence of long chain branching.

In some embodiments, the polyethylene compositions can exhibit strain hardening when characterized by elongation rheology.

In some embodiments, the polyethylene compositions can be made by any suitable polymerization method including solution polymerization, slurry polymerization, supercritical, and gas phase polymerization using supported or unsupported catalyst systems, such as a system incorporating a metallocene catalyst.

Metallocene catalysts generally require activation with a suitable co-catalyst, or activator, in order to yield an “active metallocene catalyst,” e.g., an organometallic complex with a vacant coordination site that can coordinate, insert, and polymerize olefins. Active catalyst systems generally include not only the metallocene complex, but also an activator, such as an alumoxane or a derivative thereof (for example methyl alumoxane), an ionizing activator, a Lewis acid, or a combination thereof. Alkylalumoxanes (for example methyl alumoxane and modified methylalumoxanes) are suitable as catalyst activators. The catalyst system can be supported on a carrier, typically an inorganic oxide or chloride or a resinous material such as, for example, polyethylene or silica.

Examples of metallocene catalysts/systems for producing polyethylene compositions desired herein include bridged and unbridged biscyclopentadienyl zirconium compounds (such as where the Cp rings are indenyl or fluorenyl groups).

The polyethylene compositions can be made by zirconium transition metal metallocene-type catalyst systems. Non-limiting examples of metallocene catalysts and catalyst systems useful to make the present polyethylene compositions described herein include those described in, U.S. Pat. Nos. 4,808,561; 5,017,714; 5,055,438; 5,064,802; 5,124,418; 5,153,157; 5,324,800; 5,466,649; 6,476,171; 6,225,426; 6,380,122; 6,376,410; and 7,951,873, all of which are fully incorporated herein by reference. Other non-limiting examples of metallocene catalysts and catalyst systems useful to make the present polyethylene compositions described herein include those described in WO 1996/011961; WO 1996/011960; and WO 2001/098409, all of which are fully incorporated herein by reference. Example catalyst systems include supported dimethylsilyl bis(tetrahydroindenyl) zirconium dichloride.

In some embodiments, the supported polymerization catalyst can be deposited on, bonded to, contacted with, or incorporated within, adsorbed or absorbed in, or on, a support or carrier. In other embodiments, the metallocene can be introduced onto a support by slurrying a presupported activator in oil, a hydrocarbon such as pentane, solvent, or non-solvent, then adding the metallocene as a solid while stirring. The metallocene can be finely divided solids. Although the metallocene is typically of very low solubility in the diluting medium, it is found to distribute onto the support and be active for polymerization. Very low solubilizing media such as mineral oil (e.g., Kaydo™ or Drakol™) or pentane can be used. The diluent can be filtered off and the remaining solid shows polymerization capability much as would be expected if the catalyst had been prepared by traditional methods such as contacting the catalyst with methylalumoxane in toluene, contacting with the support, followed by removal of the solvent. If the diluent is volatile, such as pentane, it can be removed under vacuum or by nitrogen purge to afford an active catalyst. The mixing time can be greater than 4 hours, but shorter times are suitable.

In a gas phase polymerization process, a continuous cycle can be employed where in one part of the cycle of a reactor, a cycling gas stream, otherwise known as a recycle stream or fluidizing medium, can be heated in the reactor by the heat of polymerization. This heat can be removed in another part of the cycle by a cooling system external to the reactor. See, e.g., U.S. Pat. Nos. 4,543,399; 4,588,790; 5,028,670; 5,317,036; 5,352,749; 5,405,922; 5,436,304; 5,453,471; 5,462,999; 5,616,661; and U.S. Pat. No. 5,668,228. To obtain the copolymers, parameters including individual flow rates of ethylene, comonomer, and hydrogen can be controlled and adjusted to obtain the desired polymer properties.

The polyethylene compositions of the present disclosure can be used to manufacture an article, e.g., a shaped article. Such an article may be a single-layer or a multi-layer article, which can be obtained by any suitable conversion techniques that apply heat, pressure or a combination thereof to obtain the shaped article. Suitable conversion techniques include, e.g., blow-molding, co-extrusion blow-molding, injection molding, injection stretch blow molding, compression molding, extrusion, pultrusion, calendering, and thermoforming. Articles provided by the present disclosure include, e.g., a pipe, a hose, a container, a utensil, a film, a sheet, a sheet product, a geomembrane, a fiber, a profile, a molding, or a liner.

The polyethylene compositions of the present disclosure can be suitable for durable applications, especially pipes, without the need for cross-linking. Pipes that include the polyethylene compositions described herein are another aspect of the present disclosure and can include monolayer pipes as well as multilayer pipes, including multilayer composite pipes.

In some embodiments, the pipes of the present disclosure can include additives such as at least one of a polymer processing aid, a thermal stabilizer, a slip agent, a nucleator, a flame retardant, a colorant, an antioxidant, a process stabilizer, a metal deactivator, or a UV protector.

In some embodiments, monolayer pipes according to the present disclosure can have one layer made from a polyethylene composition as described herein. According to some embodiments, monolayer pipes can have one layer made from a polyethylene composition as described herein together with any additional suitable additives, e.g., any additive typically used for pipe applications, such as at least one of a polymer processing aid, a thermal stabilizer, a slip agent, a nucleator, a flame retardant, a colorant, an antioxidant, a process stabilizer, a metal deactivator, or a UV protector.

Multilayer composite pipes including one or more layers, e.g., one or two layers, wherein at least one layer includes a polyethylene composition as described herein, are also possible. In some embodiments, the polyethylene compositions as described herein can be used at least for the inner layer. Such multilayer pipes can include, for example, three-layer composite pipes with the general structure PE-Adhesive-Barrier, or five-layer pipes with the general structure PE-Adhesive-Barrier-Adhesive-PE or Polyolefin-Adhesive-Barrier-Adhesive-PE. In these structures, PE refers to polyethylene layer(s) which can be made from the same or different polyethylene compositions. Suitable polyolefins can include, e.g., medium density polyethylene, low density polyethylene, linear low density polyethylene, high density polyethylene, polypropylene and polybutylene, homopolymers and copolymers. The barrier layer may be an organic polymer capable of providing the desired barrier properties, such as an ethylene-vinyl alcohol copolymer (EVOH), or a metal, for example, stainless steel or aluminum.

Multilayer coextrusion is standard practice in the pipe manufacturing industry, typically using an adhesive polymer layer to tie inside and outside PE layers to a central aluminum tube. The polyethylene compositions described herein can be suited for such composite pipe applications. Specifically, the polyethylene compositions can provide excellent processing behavior.

In some embodiments, the polyethylene pipe can have a 20° C. long term hydrostatic strength (LTHS) of from about 5 MPa to about 10.1 MPa, such as from about 8 MPa to about 9.99 MPa, such as from about 9 MPa to about 9.98 MPa, such as from about 9.5 MPa to about 9.97 MPa. In some embodiments, the polyethylene pipe can have a 20° C. long term hydrostatic strength of from about 8.0 MPa to about 8.5 MPa, from about 8 MPa to about 9 MPa, from about 8 MPA to about 9.5 MPA, or from about 9 MPa to about 9.99 MPa. In some embodiments, the polyethylene pipe can have a 20° C. long term hydrostatic strength of from about 8.0 MPa to about 9.99 MPa, such as from about 8 MPa to about 9.8 MPa, such as from about 8 MPa to about 9.74 MPa. The 20° C. long term hydrostatic strength is measured according to method ISO 1167 and method ISO 9080.

In some embodiments, the polyethylene pipe can have a categorized minimum required strength (MRS) of 8 MPa, thus classified as PE 80 pipe per method ISO 9080, ISO 1167, and/or ISO 12162.

In some embodiments, the polyethylene pipe can have a 70° C. long term hydrostatic strength (LTHS) of from about 5 MPa to about 8 MPa, such as from about 5 MPa to about 7 MPa, such as from about 5 MPa to about 6 MPa. The 70° C. long term hydrostatic strength (LTHS) is measured according to ISO 9080.

In some embodiments, the polyethylene pipe can exhibit no brittle failures at 70° C., 95° C., and/or 110° C. for at least about 1,000 hours, such as at least about 5,000 hours, such as at least about 10,000 hours, when tested per ISO 1167 and ISO 9080.

As provided herein, the present polyethylene compositions can be useful for pipes made of polyethylene of raised temperature (“PE-RT”) (also referred to as a “PE-RT pipe”). Fabricated pipe using these PE-RT qualified resins (referred to herein as “polyethylene compositions”) should meet a range of performance specifications depending on the end use of the pipe and geographically specific regulations. The PE-RT specifications are provided in ISO 22391-2 which specify the pipe characteristics for hot and cold water handling within building construction applications. The primary mechanical specification of ISO 22391-1 is the pipe's resistance to bursting under hydrodynamic (hoop) stress at various temperatures and times. In addition to long term burst resistance, a key resin characteristic is extrudability (extruder processability) since these pipes are typically small diameter fabricated at relatively fast extrusion rates which can introduce finishing issues such as melt fracture resulting in a poor surface finish and possibly impacting properties. As described below in detail, another requirement of ISO 22391-2 is an unblemished, smooth surface finish.

As noted immediately above, International Organization for Standardization (ISO) 22391-2 specifies the characteristics of pipe made of polyethylene of raised temperature resistance (“PE-RT”), Type I and Type II, intended to be used for hot and cold water installations within buildings for the conveyance of water, whether or not the water is intended for human consumption (domestic systems), and for heating systems, under the design pressures and temperatures appropriate to the class of application according to ISO 22391-1.

In an embodiment, a method of making a pipe (e.g., a polyethylene of raised temperature resistance (PE-RT) Type I pipe) is provided. The PE-RT Type I pipe can have a σ_{LPL} greater or equal to about 3.3 MPa, greater or equal to about 2.7 MPa, greater or equal to about 3.3 MPa, greater or equal to about 2.4 MPa, or greater or equal to about 6.7 MPa for class 1, 2, 4, 5, or cold water (20° C., 50 years) application, respectively, per ISO22391-2. The method includes extruding any polyethylene composition described herein in a molten state through a die to form a pipe (e.g., a PE-RT Type I pipe); and cooling the pipe.

In an embodiment, a method of making a pipe (e.g., a PE-RT Type II pipe) is provided. The PE-RT Type II pipe can have a σ_{LPL} greater or equal to about 3.5 MPa, greater or equal to about 3.4 MPa, greater or equal to about 3.4 MPa, greater or equal to about 2.9 MPa, or greater or equal to about 7.5 MPa for class 1, 2, 4, 5, or cold water (20° C., 50 years) application, respectively, per ISO22391-2. The method includes extruding any polyethylene composition described herein in a molten state through a die to form a pipe (e.g., a PE-RT Type II pipe); and cooling the pipe.

As provided herein, the present polyethylene compositions can be useful for PE 80 pipes. A PE 80 pipe is made of polyethylene, and is classified as having an MRS (at 50 years and 20° C.) of 8 MPa. PE 80 pipes can be used for gas pipe for natural gas distribution network with pressure rate up to 4 bars, drinking water pipe with pressure rate up to 16 bars, and the conveyance of water under the design pressures and temperatures appropriate to the class of application according to ISO 12162.

In some embodiments, a method of making a PE 80 pipe (a pipe having a Minimum required strength of 8 MPa includes extruding any polyethylene composition described herein in a molten state through a die to form a pipe; and cooling the pipe, wherein the MRS is per the definition of method ISO 1167, method ISO 9080, and/or method ISO 12162.

As provided herein, the present polyethylene compositions can be useful for PE 2708 pipes. A PE 2708 pipe is a PE resin pipe with a recommended maximum hydrostatic design stress (HDS) of 800 psi for water service per ASTM 2837 and Plastic Pipe Institute (PPI) Technical Report (TR) 3. PE 2708 pipes also have a hydrostatic design basis (HDB) of 1,250 psi at 73° F. per PPI TR 3 and TR 4.

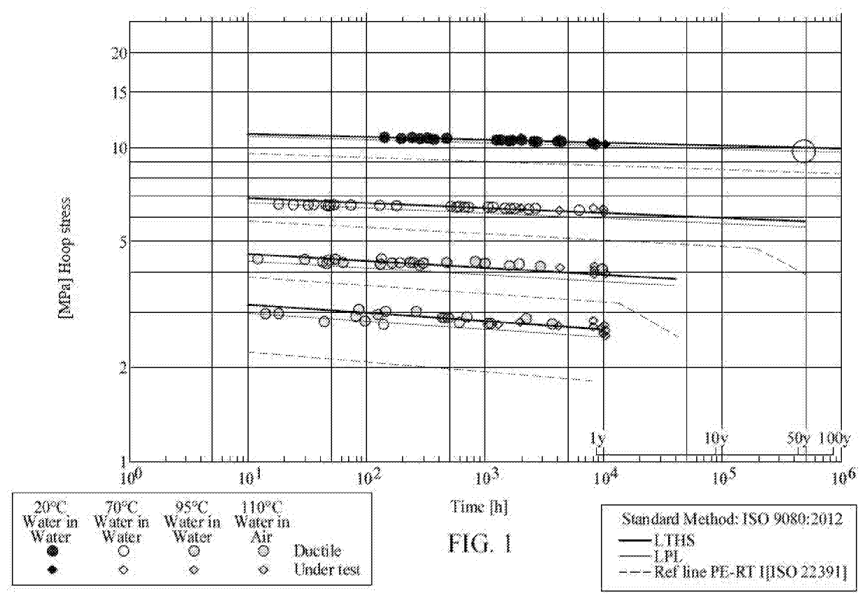

In an embodiment, a method of making a pipe having a hydrostatic design basis (HDB) of 8.6 MPa (1,250 psi) at 20° C. includes extruding any polyethylene composition described herein in a molten state through a die to form a pipe; and cooling the pipe. Other temperature and pressure combinations are shown in FIG. 1. This pipe would meet or exceed the HDB of a PE 2708 pipe set out in Plastic Pipe Institute (Irvine Texas) Technical Report (TR) 3 and TR 4, ASTM D2837, with HDB (of 1,250 psi at 73° F.) defined therein. The grade of the HDB may be established on the basis of an LTHS that has been interpolated from LTHS values obtained for one higher and one lower temperature. The following equation can be used to determine a temperature interpolated LTHS:

$${S}_{T} = {S}_{L} - \frac{( {S}_{L} - {S}_{H} ) ( ( \frac{1}{{T}_{L}} ) - ( \frac{1}{{T}_{T}} ) )}{( ( \frac{1}{{T}_{L}} ) - ( \frac{1}{{T}_{H}} ) )}$$

wherein S_{T} is LTHS at interpolation temperature (psi), S_{L} is the LTHS at the lower temperature (psi), S_{H} is the LTHS at the higher temperature (psi), T_{T} is the interpolation temperature (K), T_{L} is the lower temperature (K), and T_{H} is the higher temperature (K).

In another embodiment, any method above (or other methods) for making a pipe can include blending any polyethylene composition described herein with any additive described herein to form a blend; extruding the blend in a molten state through a die to form a pipe; and cooling the pipe.

In another embodiment, any method above (or other methods) for making a pipe by blending a post-consumer polyethylene (PE) with any polyethylene compositions described herein. The method may further include extruding the pipe. Post-consumer PE refers to objects having completed at least a first use cycle (or life cycle), e.g., having already served their first purpose. The post-consumer PE can be collected, sorted, washed, and/or dried prior to use. The post-consumer PE may be LDPE, LLDPE, MDPE and HDPE having a density between about 0.900 g/cm³ to about 0.970 g/cm³ and/or a melt index (2.16 kg) of from about 0.01 g/min to about 100 g/10 min.

In another embodiment, any method above (or other methods) for making a pipe can include beginning the pipe extruder with commercial benchmarks, then adding in a polyethylene resin described herein, and the line speed is adjusted to accommodate any output difference.

Typical extruders that can be used for the methods described herein can include a Davis-Standard Extruder, and those available from Sino-Germany JV Ningbo Fangli.

In some embodiments, any method above (or other methods) for making a pipe can include one or more of the following parameters:
1) A screw size of from about 0.5 inches to about 5 inches, such as about 3 inches.
2) A length/diameter (L/D) ratio of from about 20 to about 40, such as about 38.
3) A barrel temperature of about 300° F. to about 500° F., such as about 395° F., and ramping down to a temperature of about 410° F. to about 350° F., such as about 375° F., across 6 zones.
4) A die temperature of from about 440° F. to about 350° F., such as about 365° F., across the zones between the adapter and the die lip.
5) A screw speed (rpm) of from about 20 to about 200, such as about 38.
6) A percent of motor load of from about 15% to about 85%, such as about 42%.
7) A line speed of from about 10 feet/min to about 165 feet/min, such as from about 50 feet/min to about 70 feet/min.
8) An output rate of from about 50 pounds/hour (lbs/hr) to about 1,000 lbs/hr, such as about 220 lbs/hr.
9) A melting temperature of from about 350° F. to about 450° F., such as about 375° F.
10) A cooling water temperature of from about 5° C. to about 23° C., such as about 15° C.
11) A vacuum of from about −15 psi to about −0.1 psi, such as about −4.75 psi.

In some embodiments, any method above (or other methods) for making a pipe can include one or more of the following parameters:
1) A line speed of from about 3 m/min to about 45 m/min, for example about 40 m/min.
2) A maximum extruder rpm of about 140 rpm or lower, such as about 120 rpm or lower.
3) An output rate of from about 20 kg/hr to about 500 kg/hr, such as about 300 kg/hr.
4) Temperatures for various zones of from about 175° C. to about 275° C., such as from about 185° C. to about 200° C. For example, Zones 1-4 may be about 185° C., about 190° C., about 195° C., and about 200° C., respectively.
5) An adapter temperature of from about 175° C. to about 235° C., such as about 205° C.
6) A die temperature of from about 175° C. to about 235° C., such as about 210° C.
7) A cooling water temperature of from about 3° C. to about 25° C., such as about 23° C.
8) A vacuum of from about −0.2 psi to about 0 psi, such as about −0.1 psi.

Exemplary commercial scale parameters are shown in Table A (Davis-Standard Extruder) and Table B (Sino-Germany JV Ningbo Fangli).

TABLE A

| Screw Size | 3 | in |
|---|---|---|
| L/D ratio | 38 | |
| Feed bore | groove | |
| Barrel temperatures | 395° F. ramping down to 375° F. | |
| Die temperature | 365° | F. |
| Screw speed | 38 | rpm |
| % of motor load | 42% | |
| Line speed | 50-70 | ft/min |
| Output rate | 220 | lbs/hr |
| Melting temperature | 370° F.-375° F. | |
| Cooling water temperature | 60° | F. |
| Vacuum | −4.75 | psi |

TABLE B

| Line speed | 40 | m/min |
|---|---|---|
| Maximum extruder rpm | 140 | rpm |
| Output rate | 300 | kg/h |
| Temperatures of Zones 1-4 | 185° C., 190° C., 195° C., 200° C. | |
| Adapter temperature | 205° | C. |
| Die temperature | 210° | C. |
| Cooling water temperature | 23° | C. |
| Vacuum | −0.015 | bar |

### Evaluation of σ_{LPL} Values

Pipe material is evaluated in accordance with ISO 9080 or equivalent, with internal pressure tests carried out in accordance with ISO 1167-1 and ISO 1167-2, to determine the σ_{LPL} values. The σ_{LPL} value is at least as high as the corresponding values of the reference curves given in FIG. 1 (taken from ISO 24033:2009) over the complete range of times. Alternatively, one equivalent way of evaluation is to calculate the σ_{LPL} value for each temperature individually.

The reference curves for the pipe samples in FIG. 1 in the temperature range of 10° C. to 95° C. are derived from Equations (1) and (2). First branch (i.e. the left-hand portion of the lines shown in FIG. 1):

Log(t)=−190.481−((58,291.035(log σ))/T)+(78,763.07/T)+119.877(log 6). Eq. 1

Second branch (i.e. the right-hand portion of the lines shown in FIG. 1):

Log(t)=−27.7954−((1,723.318(log σ))/T)+(11,150.56/T). Eq. 2

In equations 1 and 2, “T” refers to temperature, and t refers to time. The 110° C. values are determined separately using water inside and air outside the test specimen and are not derived from Equations (1) and (2).

In order to demonstrate conformance to the reference lines, pipe samples should be tested in accordance with ISO 1167-1 and ISO 1167-2 at the following temperatures: 20° C.; 60° C. to 70° C.; and 95° C., and at various hoop stresses such that, at each of the temperatures, at least three failure times fall in each of the following time intervals: 10 hours to 100 hours; 100 hours to 1,000 hours; 1,000 hours to 8,760 hours and over. In tests lasting more than 8,760 hours without failure, any test time after 8,760 hours can be considered as the failure time.

### Evaluation of σ_{LTHS} Values

σ_{LTHS} is determined in accordance with ISO 9080, ISO 1167-1 and ISO 1167-2. σ_{LTHS} the predicted mean strength while σ_{LPL} is the predicted 97.5% lower confidence level predicted strength.

Environmental stress crack resistance was determined by ASTM D1693 condition B with 10% Igepal at 50° C.

Minimum required strength (MRS) was determined by ISO 9080, ISO 1167-1 and ISO 1167-2.

### EXAMPLES

Examples 1-6 were prepared via a gas phase polymerization process using ethylene and the comonomer as hexene, as described herein. Reactor granules were compounded with a Coperion ZSK-57 twin screw extruder at 150 lbs/hr output rate with a standard antioxidant and metal deactivation package.

Example 1 (Ex. 1) is a polyethylene composition having a density of 0.934 g/cm³ and a melt index (MI) of 0.67 (190° C./2.16 kg).

Example 2 (Ex. 2) is a polyethylene composition having a density of 0.938 g/cm³ and a MI of 0.74 (190° C./2.16 kg).

Example 3 (Ex. 3) is a polyethylene composition having a density of 0.935 g/cm³ and a melt index of 0.52 (190° C./2.16 kg).

Example 4 (Ex. 4) is a polyethylene composition having a density of 0.936 g/cm³ and a melt index of 0.63 (190° C./2.16).

Example 5 (Ex. 5) is a polyethylene composition having a density of 0.935 g/cm³ and a melt index of 0.47 (190° C./2.16).

Example 6 (Ex. 6) is a polyethylene composition having a density of 0.933 g/cm³ and a melt index of 0.60 (190° C./2.16).

Comparative 1 (C1) is a single site catalyzed polyethylene.

Comparative 2 (C2) is a commercial PE-RT type I resin, metallocene medium density polyethylene.

Comparative 3 (C3) is a commercial PE-RT type I resin metallocene medium density polyethylene.

Comparative 4 (C4) is a commercial PE-RT type I resin, Ziegler-Natta medium density ethylene-1-octene polyethylene.

Comparative 5 (C5) is a commercial PE-RT type I resin, metallocene polyethylene.

Comparative 6 (C6) is a PE-RT Type I resin, Ziegler-Natta ethylene-1-octene polyethylene.

The physical properties of the pellets of Examples 1-6 relative to industry standards (Comparatives 1-6) are summarized in Table 1-3. The σ_{LPL} values of C2 and C6 (Table 4) are publically disclosed information.

TABLE 1

| | Ex. 1 | Ex. 2 | Ex. 3 | C1 | C2 | C3 | C4 | C5 | C6 |
|---|---|---|---|---|---|---|---|---|---|
| MI 2.16 | 0.67 | 0.74 | 0.52 | 0.27 | 0.67 | 0.6 | 0.66 | 0.66 | 0.71 |
| (g/10 min) | | | | | | | | | |
| MIR | 50 | 51 | 50 | 59 | 33 | 30 | 24 | 18 | 26 |
| Density (g/cm³) | 0.934 | 0.938 | 0.935 | 0.94 | 0.939 | 0.935 | 0.934 | 0.936 | 0.933 |
| Flexural Modulus | 727 | 761 | 721 | 830 | 845 | 726 | 664 | 741 | — |
| (1% Secant) | | | | | | | | | |
| Tensile strength | 17.8 | 19.3 | 18.5 | 20.4 | 20.2 | 18.3 | 17.4 | 18.7 | — |
| at yield (MPa) | | | | | | | | | |
| Elongation at | 10.4 | 11 | 11.3 | 11.2 | 10.9 | 10.5 | 14.2 | 12.2 | — |
| yield (%) | | | | | | | | | |
| Comonomer (C6) | 2.56 | 2.07 | 2.31 | 1.52 | 1.68 | 1.91 | 3.80 (C8) | 1.74 | — |
| %, by NMR | | | | | | | | | |
| g′ᵥᵢₛ | 0.997 | — | — | — | — | — | — | — | — |
| ESCR (F50), | >3,000 | >3,000 | >3,000 | — | — | — | — | — | — |
| hours | | | | | | | | | |

Examples 1-6 do not contain a polymer processing additive, while conventional compositions (e.g., C3) do contain a polymer processing additive. One benefit, then, is that the compositions of the present disclosure can be more economical and sustainable.

In one experiment, Examples 4, 5 and 6 were extruded by using an industrial scale pipe extruder to produce 20 mm OD and 2 mm WT monolayer pipes, with comparative example 3 as the benchmark. The physical properties of Examples 4-6 relative to industry standards (Comparative 3) are summarized in Table 2. Examples 4-6, having a similar melt index because of their higher MIR and LCB, demonstrated about 10% energy savings at the same extruder line speed, output rate, and operation conditions.

TABLE 2

| | Ex. 4 | Ex. 5 | Ex. 6 | C3 |
|---|---|---|---|---|
| MI 2.16 (g/10 min) | 0.63 | 0.47 | 0.6 | 0.6 |
| MIR | 45 | 50 | 45 | 30 |
| Density (g/cm³) | 0.936 | 0.935 | 0.933 | 0.936 |
| Screw Speed (rpm) | 95.1 | 95.1 | 98.1 | 97.3 |
| Amps (A) | 174.3 | 173.2 | 174.8 | 196 |
| Amps Rate (%) | 77.8 | 77.4 | 78.1 | 87.5 |
| Line Speed (m/min) | 43 | 43 | 43 | 43 |

In another pipe extrusion experiment using a different industrial scale pipe extruder to make a 20 mm outer diameter (OD) and 2 mm wall thickness (WT) monolayer pipes, Example 5 showed significantly lower torque compared with Comparative 2 when running at similar and optimized conditions. Results are shown in Table 3.

TABLE 3

| | Ex. 5 | C3 |
|---|---|---|
| MI 2.16 (g/10 min) | 0.47 | 0.67 |
| MIR | 50 | 33 |
| Density (g/cm³) | 0.935 | 0.9398 |
| Line Speed (m/min) | 35 | 33 |
| Output (kg/h) | 235 | 215 |
| Screw Speed (rpm) | 92 | 81 |
| Torque (%) | 41 | 46 |

Monolayer pipe samples for strength testing were extruded by using an industrial pipe extruder. The nominal dimensions of the pipe samples were 20 mm OD and 2 mm WT. Various line speeds were tested from 10 to 40 meters per minutes against a commercial benchmark. Pipes made from Examples 1-6 were found to have good dimension and surface appearance by commercial standards.

Pipe samples were submitted for long term hydrostatic strength testing (per ISO 9080) at 4 temperatures: 20° C., 70° C., 95° C., and 110° C. In the tests, each pipe specimen was pressurized to create a desired hoop stress on the wall circumference. The testing pressures and stresses were managed and maintained such that the pipes would burst in ductile mode from about 10 hours to about 10,000 hours. The distribution of the time to burst was managed to meet the requirements set by ISO 9080. The pipe testing data showed it met the hydrostatic strength requirement of PE 80 per ISO of method ISO 1167, method ISO 9080, and/or method ISO 12162; PE-RT Type I, PE-RT Type II applications per ISO 22391; and PE 2708 per ASTM D2837.

The data in Table 4 (Ex. 3 is also shown in FIG. 1) show that the example polyethylene compositions exhibit excellent hoop stress performance at elevated temperatures, making them well-suited for use in hot and cold water pipe systems. Moreover, the hoop stress tests conducted on the example polyethylene compositions at 20° C., 80° C., 95° C., and 110° C. exhibited no “knee” in hydrostatic stress rupture curves before 10,000 hours. In addition, Example 3 showed no brittle burst at 95° C., while Comparative 6 showed brittle burst at 95° C.

TABLE 4
ISO 9080 Evaluation

| | Ex. 1 | Ex. 2 | Ex. 3 | C2 | C6 |
|---|---|---|---|---|---|
| σ_{LPL}, MPa (20° C., 50 yrs.) | 9.06 | 9.34 | 9.74 | 8.70 | 9.05 |
| σ_{LTHS}, MPa (20° C., 50 yrs.) | 9.42 | 9.64 | 9.97 | — | — |
| σ_{LPL}, MPa (70° C., 50 yrs.) | 4.97 | 5.22 | 5.59 | — | — |
| σ_{LTHS}, MPa (70° C., 50 yrs.) | 5.31 | 5.50 | 5.82 | — | — |

Table 5 shows the results of an example polyethylene composition under design hoop stress and conformity check with ISO 22391-2. The data reveals that the polyethylene composition meets or exceeds the requirements for PE-RT Type I pipes for class 1, 2, 4, 5, or cold water (20° C., 50 years) application, respectively, per ISO22391-2. The data also shows that the polyethylene composition meets or exceeds the requirements for PE-RT Type II pipes for class 1, 2, 4, 5, or cold water (20° C., 50 years) application, respectively, per ISO22391-2.

TABLE 5
ISO 22391-2 Evaluation

| | | Design Stress σ_{LPL} | Design Stress σ_{LPL} |
|---|---|---|---|
| | Ex. 3 | (MPa) | (MPa) |
| Application Class | (MPa) | PE-RT Type I | PE-RT Type II |
| Class 1 | 3.90 | 3.29 | 3.53 |
| Class 2 | 3.73 | 2.68 | 3.37 |
| Class 4 | 3.68 | 3.25 | 3.38 |
| Class 5 | 3.19 | 2.38 | 2.88 |
| 20° C., 50 yrs. | 7.80 | 6.68 | 7.47 |

Extensional rheology was determined by the following procedure. Extensional Rheology was performed on an Anton-Paar MCR 501 or TA Instruments DHR-3 using a SER Universal Testing Platform (Xpansion Instruments, LLC), model SER2-P or SER3-G. The SER (Sentmanat Extensional Rheometer) Testing Platform is described in U.S. Pat. Nos. 6,578,413 and 6,691,569. A general description of transient uniaxial extensional viscosity measurements is provided, for example, in Gabriel, C. et al. (2003) “Strain hardening of various polyolefins in uniaxial elongational flow,” The Society Of Rheology, Inc., J. Rheol., v. 47(3), pp. 619-630; and Sentmanat, M. et al. (2005) “Measuring the transient extensional rheology of polyethylene melts using the SER universal testing platform,” The Society of Rheology, Inc., J. Rheol., v. 49(3), pp. 585-606. Strain hardening occurs when a polymer is subjected to uniaxial extension and the transient extensional viscosity increases more than what is predicted from linear viscoelastic theory. Strain hardening is observed as abrupt upswing of the extensional viscosity in the transient extensional viscosity versus time plot. A strain hardening ratio (SHR) is used to characterize the upswing in extensional viscosity and is defined as the ratio of the maximum transient extensional viscosity over three times the value of the transient zero-shear-rate viscosity at the same strain. Strain hardening is present in the material when the ratio is greater than 1. The SER instrument consists of paired master and slave windup drums mounted on bearings housed within a chassis and mechanically coupled via intermeshing gears. Rotation of the drive shaft results in a rotation of the affixed master drum and an equal but opposite rotation of the slave drum which causes the ends of the polymer sample to be sound up onto the drums resulting in the sample stretched. The sample is mounted to the drums via securing clamps in most cases. In addition to the extensional test, samples are also tested using transient steady shear conditions and matched to the extensional data using a correlation factor of three. This provides the linear viscoelastic envelope (LVE). Rectangular sample specimens with dimensions approximately 18.0 mm long×12.70 mm wide are mounted on the SER fixture. Samples are generally tested at three Hencky strain rates: 0.01 s⁻¹, 0.1 s⁻¹, and 1 s⁻¹. The testing temperature is 150° C. The polymer samples were prepared as follows: the sample specimens were hot pressed at 190° C., mounted to the fixture, and equilibrated at 150° C.

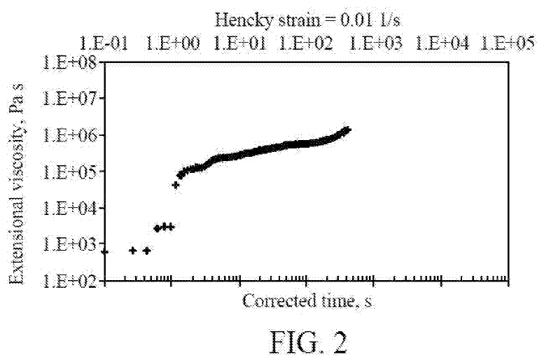

FIG. 2 shows the extensional viscosity of Ex. 3. The uptick of the curve clearly showed a strain hardening phenomenon which is typical considered an indication of long chain branching.

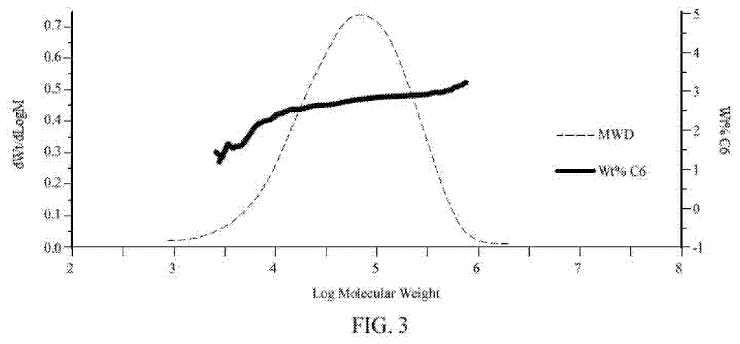

FIG. 3 shows the molecular weight properties of Ex. 3. The molecular weight properties were obtained using DRI analysis as described above. For this example, the polyethylene composition is unimodal, has a Mw of about 105,200 g/mol, a Mn of about 25,800 g/mol, a Mz of about 247,900 g/mol, and a Mw/Mn of about 4.0.

Benefits that may be achieved by the compositions, articles, and methods described herein include medium density metallocene polyethylene compositions suitable for pipe applications. Relative to conventional polyethylene compositions, the example polyethylene compositions as described herein are able to achieve a higher LTHS and σLPL, which enables the pipes to hold a higher pressure and/or have a better safety factor when holding the same water pressure. In addition, the example polyethylene compositions as described herein have a higher melt index ratio (such as greater than 40, such as greater than 50) than traditional Ziegler-Natta resins and other metallocene resins and LCB, it have benefits of significant energy savings and other process advantages such as glossy surface. Such a combination of properties is not achievable when using Ziegler-Natta catalysts and other metallocene catalysts. The example polyethylene compositions as described herein also have a better pressure rating than conventional polyethylene compositions and are more flexible than conventional pipes. For example, the polyethylene pipes described herein are more flexible than conventional PE 80 pipes, allowing for less pipe connections needed during installation and use. Moreover, the example polyethylene compositions as described herein have better processability than conventional polyethylene compositions, such that the example polyethylene compositions can be processed at high speeds without the use of polymer processing additives.

All documents described herein are incorporated by reference herein, including any priority documents and/or testing procedures to the extent they are not inconsistent with this text. As is apparent from the foregoing general description and the specific embodiments, while forms of the embodiments have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “I” preceding the recitation of the composition, element, or elements and vice versa, e.g., the terms “comprising,” “consisting essentially of,” “consisting of” also include the product of the combinations of elements listed after the term.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

While the present disclosure has been described with respect to a number of embodiments and examples, those skilled in the art, having benefit of the present disclosure, will appreciate that other embodiments can be devised which do not depart from the scope and spirit of the present disclosure as described herein.

What is claimed is:

1. A pipe, comprising:
a polyethylene composition comprising ethylene and an alpha-olefin comonomer, wherein the polyethylene composition has:
a melt index (MI) of from 0.1 g/10 min to 1 g/10 min, measured according to method ASTM D1238,
a density of from 0.93 g/cm³ to 0.94 g/cm³, measured according to method ASTM D1505, and
a melt index ratio (MIR) of from 40 to 70, measured according to method ASTM D1238,
and wherein the pipe has a 20° C. long term hydrostatic strength (LTHS) of from 5 MPa to 10.1 MPa, measured according to method ISO 1167 and method ISO 9080.

2. The pipe of claim 1, wherein the MI of the polyethylene composition is from 0.2 g/10 min to 0.8 g/10 min, and the density of the polyethylene composition is from 0.932 g/cm³ to 0.938 g/cm³.

3. The pipe of claim 1, wherein the MI of the polyethylene composition is of from 0.4 g/10 min to 0.6 g/10 min, and the density of the polyethylene composition is from 0.934 g/cm³ to 0.937 g/cm³.

4. The pipe of claim 1, wherein the MIR of the polyethylene composition is from 50 to 60.

5. The pipe of claim 1, wherein the polyethylene composition has a long chain branching index (g′ᵥᵢₛ) value of 0.90 or less.

6. The pipe of claim 1, wherein the alpha-olefin comonomer comprises a C₃ to C₁₀ alpha-olefin comonomer.

7. The pipe of claim 1, wherein the polyethylene composition comprises at least one of a polymer processing aid, a thermal stabilizer, a slip agent, a nucleator, a flame retardant, a colorant, an antioxidant, a process stabilizer, a metal deactivator, or a UV protector.

8. The pipe of claim 1, wherein the polyethylene composition is a unimodal metallocene polyethylene composition.

9. The pipe of claim 1, wherein the pipe has a F50 of greater than 1,000 hours when measured according to environmental stress crack resistance (ESCR) condition B with 10% Igepal per ASTM D1693.

10. The pipe of claim 1, wherein the pipe has a categorized minimum required strength (MRS) of 8 MPa or greater, measured according to method ISO 1167 and method ISO 9080.

11. The pipe of claim 1, wherein the pipe has a 20° C. long term hydrostatic strength (LTHS) of from 5 MPa to 8.99 MPa, measured according to method ISO 1167 and method ISO 9080.

12. The pipe of claim 1, wherein the pipe has a 20° C. LTHS of from 9 MPa to 9.99 MPa, measured according to method ISO 1167 and method ISO 9080.

13. The pipe of claim 1, wherein the pipe has a 20° C. LTHS of from 9.5 MPa to 9.99 MPa, measured according to method ISO 1167 and method ISO 9080.

14. The pipe of claim 1, wherein the pipe has a 70° C. long term hydrostatic strength (LTHS) of from 5 MPa to 6 MPa, measured according to method ISO 9080.

15. The pipe of claim 1, wherein the pipe exhibits no brittle failures for 10,000 hours at 70° C. when tested per method ISO 1167 and method ISO 9080.

16. The pipe of claim 1, wherein the pipe exhibits no brittle failures for 10,000 hours at 95° C. when tested per method ISO 1167 and method ISO 9080.

17. The pipe of claim 1, wherein the pipe exhibits no brittle failures for 10,000 hours at 110° C. when tested per method ISO 1167 and method ISO 9080.

18. A method of making a pipe, comprising:
extruding a polyethylene composition in a molten state through a die to form a pipe; and
cooling the pipe;
wherein the polyethylene composition comprises ethylene and an alpha-olefin comonomer, and has:
a melt index (MI) of from 0.1 g/10 min to 1 g/10 min, measured according to method ASTM D1238,
a density of from 0.93 g/cm³ to 0.94 g/cm³, measured according to method ASTM D1505, and
a melt index ratio (MIR) of from 40 to 70, measured according to method ASTM D1238;
further wherein the pipe has one or more of the following properties (a)-(c):
(a) a minimum required strength (MRS) of 8 MPa, wherein the MRS is per the definition of method ISO 1167 and method ISO 9080;
(b) a hydrostatic design basis (HDB) of 1,250 psi at 73° F., wherein the HDB is per the definition of Plastic Pipe Institute (Irvine Texas) Technical Report (TR) 3 and TR 4, ASTM D2837; or
(c) a σ_{LPL} equal to or greater than 3.3 MPa, 2.7 MPa, 3.3 MPa, 2.4 MPa, or 6.7 MPa, respectively, for each of class 1, 2, 4, 5, or cold water (20° C., 50 years) application, per method ISO 22391-2.

19. The method of claim 18, wherein the polyethylene composition of claim 1 is blended with a colorant to form a blend, and the blend comprising the polyethylene composition is extruded in the molten state through the die to form the pipe.

20. A polyethylene composition, comprising:
ethylene and an alpha-olefin comonomer, wherein the polyethylene composition has:
a melt index (MI) of from 0.1 g/10 min to 1 g/10 min, measured according to method ASTM D1238,
a density of from 0.93 g/cm³ to 0.94 g/cm³, measured according to method ASTM D1505, and
a melt index ratio (MIR) of from 40 to 70, measured according to method ASTM D1238;
further wherein the polyethylene composition is a unimodal metallocene polyethylene composition.
